(19) United States
(12) Patent Application Publication
(10) Pub. No.: US 2012/0109747 A1
(43) Pub. Date: May 3, 2012

(54) METHODS OF MARKETING MEDICAL SERVICES USING SOFTWARE APPLICATIONS

(75) Inventor: Mel Bircoll, Los Angeles, CA (US)

(73) Assignee: BIRSECT, LLC, Encinitas, CA (US)

(21) Appl. No.: 13/287,958

(22) Filed: Nov. 2, 2011

Related U.S. Application Data
(60) Provisional application No. 61/409,874, filed on Nov. 3, 2010.

(51) Int. Cl. G06Q 30/02

(52) U.S. Cl. 705/14.52

(57) ABSTRACT

The present application relates systems, and methods of using the systems disclosed herein for marketing services and business methods for marketing services. In several embodiments, the system and methods are used to market premium medical related services and provide at least medical service providers with a mechanism to invest in the system for potential future investment returns.

### RELATED CASES

This application claims the benefit of U.S. Provisional Application Ser. No. 61/409,874 filed on Nov. 3, 2010, which is incorporated in its entirety by reference herein.

### FIELD

This disclosure is directed generally to systems, and methods of using the same, for marketing services and business methods for marketing services. In some embodiments, the system and methods, including business methods, may be used to market and advertise premium medical related services and provide at least medical service providers with a way to invest in the system for potential future investment returns.

### BACKGROUND

There are several different approaches medical service providers (e.g doctors, specialists, therapists, clinics, medical groups, etc.) may pursue to advertise and market their services within a geographic area in order to attract new patients. In some cases, medical service providers spend a considerable amount of their income on advertising and may generally only receive potential patients who respond to their advertisements as a return on their advertising investments.

Advertising entities have been able to make profits from providing medical service providers with advertising services. For example, an advertising company may advertise products and/or services available within a generally defined geographic area and generally sell as many advertising subscriptions as necessary in order to generate a profit for the advertising company. This model may decrease the cost of advertising for a medical service provider in comparison to the medical service provider having to publish and distribute their own advertisements. However, because the advertising entity makes a profit from acquiring advertising subscriptions, the advertising entity will generally strive to acquire at least as many advertising subscriptions as necessary to generate a profit. Therefore, subscribing medical service providers may become competitors of other subscribing medical service providers of the same advertising company. In addition, because advertising companies generally strive to acquire at least as many advertising subscriptions necessary to generate a profit, there may be a lack in quality of service providers being advertised by an advertising entity.

An additional example model that has been used by some advertising companies is to provide advertising in exchange for at least partial ownership of a medical service provider's practice. Although this may reduce some costs to a medical service provider, the advertising company may gain at least some ownership and partial control over the medical service provider which may subject the advertising company to unwanted medical legal liability. Additionally, medical service providers may prefer to maintain generally complete control and/or ownership of their practice.

### SUMMARY

In several embodiments, there is provided herein a medical marketing service system comprising one or more computer processors with a computer-readable storage media in communication with the one or more computer processors, an electronic, searchable database stored on the computer-readable storage media that comprises information related to medical services, the database configured to store data relating to medical services offered by each of a plurality of medical service providers, and a network port configured to receive information from an individual, the information relating to desired medical services. In several embodiments, each of said medical service providers pay a fee to contract with said medical marketing service to have its data maintained in said database in an active referral status. In several embodiments the one or more computer processors are configured to query said database based on the information received from said individual and, based on a plurality of evaluation factors, identify a best fit medical service provider from said plurality of medical service providers stored in the database and having an active referral status. In some embodiments, the evaluation factors comprise one or more of specialization in a particular medical procedure, geographic location, patient feedback, outside medical service provider rankings, number of medical procedures performed, duration of contract with said medical marketing service, revenue generated for said medical marketing service, and adherence to contractual terms with said medical marketing service. In several embodiments, after identification of said best fit medical service provider, the system transmits an advertisement to said individual comprising information identifying the services provided by said best fit medical service provider, but without specifically identifying said best fit medical service provider. As such, the system provides the user with all the preliminary information needed to evaluate their need for a medical service, and in some embodiments, the system provides preliminary diagnosis or examination. However, in several embodiments, only after the user has made a decision to proceed with a medical service does the system provide the user with the specific identity of a medical service provider.

In several embodiments, there is also provided a method for marketing a particular medical service comprising receiving information from an individual seeking a particular medical service, said information comprising information regarding the particular medical service sought, using one or more computer processors to query an electronic, searchable database stored on computer-readable storage media that comprises, said database comprising data relating to medical services offered by each of a plurality of medical service providers, and transmitting an advertisement to said individual comprising information identifying the services provided by said best fit medical service provider, but without specifically identifying said best fit medical service provider, thereby marketing a particular medical service.

In several embodiments, each of said medical service providers have contracted with a marketing service that houses said database to have its data maintained in said database in an active referral status and said database categorizes said medical service providers based on at least one particular medical service which said medical service provider provides. In several embodiments, the query identifies, based on the information received from said individual and, based on a plurality of evaluation factors, identify a best fit medical service provider from said plurality of medical service providers stored in the database and having an active referral status. In several embodiments, the evaluation factors comprise one or more of specialization in a particular medical procedure, geographic location, patient feedback, outside medical service provider rankings, number of medical procedures performed, duration of contract with said medical marketing service, revenue generated for said medical marketing service, and/or adherence to contractual terms with said medical marketing service.

### DETAILED DESCRIPTION

There exists a need for way in which medical service providers can advertise their services efficiently (e.g., limited to no competition with other subscribing service providers of the same advertising company, not having to give up any ownership of their practice to advertising entities, etc.) and have a financial incentive to pay an advertising company for advertisement (e.g., generally lower cost in comparison to the medical service providers advertising independently for themselves, potential future investment returns, etc.). Additionally, there is a need for an advertising entity to assist in enabling people (e.g., potential patients) to more easily and conveniently find a single, or a limited number of, premium medical related service providers within a geographic area. As used herein, the term “service provider” shall be given its ordinary meaning and shall also refer to a medical service provider (or other variety of service provider disclosed herein) including an individual physician as well as a plurality of physicians that make up a group practice.

The advertising and marketing systems and methods, including business methods, described herein meet these and other such needs, for instance, in part, by providing a system (which in several embodiments optionally includes one or more computers or computer processors, computer programs, informational databases, computer-readable media or computer storage device, such as hard drives, solid state memory, optical disc, and/or the like) that includes information related to medical related services. In addition, in several embodiments of the advertising and marketing systems described (hereinafter the “system”), the system may store and transfer information to and from people (e.g., medical service providers subscribing to the system, potential patients, etc.) interacting with the system. In some embodiments, one or more medical service providers subscribe with the system (e.g., by forming a contract with the system and/or paying money to the system, etc.), and the system may advertise and market one or more of the subscribing service providers' services nationally and/or internationally. In several embodiments, the contractual arrangement between the medical service provider and the system (as discussed more below) is a prospective contract based on previous value of a specific medical service provider. In several embodiments, it is the system itself that is externally recognizable by potential patients, not the one or more individual medical service providers that subscribe and/or invest in the system. As such, in several embodiments, should one medical service provider opt out of their subscription and/or investment in the system, the system enables a seamless transition of potential patients to another medical service provider of the system within the same geographic area. Thus, despite the withdrawal of one or more medical service providers from the system, the system continues to provide potential patients with access to premium medical services from other medical service provider subscribing to and/or investing in the system.

Some embodiments of the system include enabling a user to access the system (e.g., locally via a computer or remotely via a computer accessing the internet) on various user-interactive and information levels. For example, the system may provide a user with a user-interactive website that the user may access via the internet. A user may visit a website of the system and view one or more categories and/or types of information (e.g., medically related information, one or more lists of common questions and answers, information about the system and what it can offer a user, etc.). In addition, a user may access the system on additional levels, such as by registering with the system via the internet and obtaining a login and password for future personalized and confidential interaction with the system—such as through one or more websites of the system. In several embodiments, informational databases of user information are stored within the system, and processed, based on the information provided in order to match the services a potential patient desires with the services provided by a medical service provider contracted to the system. Some embodiments of the system enable a user who has registered with the system the ability to obtain more personalized or tailored information (e.g., based on the user's submission of more personalized questions and information to the system). Furthermore, in some embodiments, the user may purchase additional levels of services and/or features provided by the system (e.g., medical related “canned” digital consultation(s)). In several embodiments, a database of information related to medical services is polled via the system, based on the user information input into the system, and an appropriate digital consultation is returned to the user. However, the until such time as the user makes a determination to continue with a specific medical service, the user does not receive the identity of a specific medical practitioner that will be performing the service desired. Rather, the user interacts with the system only (or a clinic tied to the system)

The system and methods of their use provided herein represent advancement in systems and methods for providing people with the ability to learn about and receive preliminary information related to premium service providers within a geographic area. Furthermore, the system and methods of their use provided herein represent an advance in systems and methods for providing advertising services for medical related service providers. In some embodiments, the system enables medical service providers to invest (e.g., becoming a partial owner of the system—such as by buying stock options, etc.) in the system. This may enable medical service providers (or any individual who invests in the system) to obtain investment returns from the system. In some embodiments, the investment and ownership (either partial or complete) provides an advantage to individuals and entities, including medical service providers who subscribe to the system, in the form of investment returns after retirement. The success of the system as a whole functions as an inducement for service providers. While investment in the system, in some embodiments can initially be viewed as similar to numerous other investment opportunities for a service provider, it is the success of the system as a whole (in advertising and providing premium medical services) that generates loyalty to the system among the providers. Loyalty is generated based on continued monitoring by the system of the revenue and quality of service (among other parameters) of each of the service providers. The maintenance of a high quality of service providers coordinately fosters the success of the system as a whole, and therefore provides returns (and additional inducement/loyalty to the system) to the service providers.

In several embodiments, the main revenue stream (and quality control mechanism) for the system is the prospective contract between the system and the service provider. The contract, and the associated fee, permit the service providers to maintain active referral status within the system. As discussed herein, in some embodiments, the prospective contract is 12 months in duration. As the contract term elapses, each provider is monitored based on their revenue generated for the system, number of procedures performed, adherence to contractual terms, etc. In several embodiments, one or more computer programs are used by a service provider to report back to the system, the information of the report being stored in one or more informational databases, which are later analyzed by an appropriate algorithm in order to allow the system to determine if the provider has complied with contractual terms. It is this monitoring that serves to not only maintain a high quality of service provider within the system (e.g., those providers that do not meet the minimal requirements of the contract will not have a renewed contract) but also to generate revenue for the system, based on the potential indefinite duration of the contract (and its associated fee, which increases as system revenues increase). For example, in some embodiments, a provider that continues to renew a contract year after year may be required to pay an increased contract fee, but at the same time benefits to a greater extent in returns because of the maintenance of high quality of service advertised by and provided through the system. As discussed herein, in some embodiments, a contract with the system can be continued after retirement of a service provider, or by the heirs of a service provider.

In some embodiments of the system and business methods, the system may offer various types of investments into the system as inducements to medical service providers (e.g., dividends during the period of investment). Furthermore, these inducements may be presented to medical service providers as a type of reward for maintaining good compliance with the contractual obligations of the system.

In addition, in some embodiments, after investing in the system, a medical service provider's investment is not bound by an expiring contract. For example, the medical service provider, or any investor of the system, may continue their investment (which may be bound by a contractual agreement) in the system indefinitely. Therefore, those who invest in the system may continue to collect financial returns from the system as long as they desire to maintain an investment in the system—even after retirement For example, a medical service provider may form a contractual agreement (e.g. for advertising, such contract not being dependent on investment) with the system to have the system continue advertising the system (and thus, indirectly, the remaining medical service providers that subscribe to the system) even though a specific medical service provider may no longer be actively providing medical services.

Therefore, the system may continue to acquire benefits (i.e., subscription costs) from a retired medical service provider while the retired service provider continues to acquire investment returns from the system for as long as the contractual relationship is maintained in good standing (i.e., subscription payments are made, compliance with contractual terms are met, etc.). In several embodiments, the contractual arrangement between the medical service provider and the system (as discussed more below) is a prospective contract based on previous value of a specific medical service provider. For example, should a medical service provider fail to provide sufficient value to merit continued inclusion within the system, the contract between the medical service provider and the system may not be renewed.

However, in several embodiments, the system is structured such that the subscription of the medical service providers, and the potential continuous returns from the system act not only to further bind the medical service provider to the system, but also as an inducement to have the medical service provider value the success of the system above and beyond the success of that medical service provider alone. This is because the success of the system as a whole, in some embodiments, provides a greater return to each individual medical service provider that would be realized by the medical service provider outside the context of the system. Moreover, the system benefits in that the medical service providers contracted to the system are interested in and benefit from the success of the system as a whole.

Advantageously, the system is structured to receive additional subscribers (e.g., medical service providers) throughout the year. For example, each medical service provider is on its own prospectively renewable 12 month contract. A medical service provider may execute a contract at any time throughout their career, which enables the system to receive additional subscribing medical service providers at times that are most advantageous to the medical service provider. In some embodiments, a medical service provider may execute a prospective 12 month contract during their retirement, providing they own an ongoing service (e.g, a clinic) that can be evaluated as to system standards.

In addition, a person's investment in the system may be inheritable so that after an investor's death a family member may continue to collect financial returns from the original investor's investment into the system. Therefore, the contractual agreement formed between the service provider and the system may be transferred, or inherited, so that the benefits of the contractual agreement may continue to be acquired by a party designated by the service provider (i.e., wife, husband, child, etc.) even after the service provider's death.

Some benefits of the system include enabling at least the service providers who subscribe to the system to maintain complete ownership of their practice while obtaining at least the benefits offered by the system (e.g., options to invest in the system, advertising and marketing of the service provider's one or more services, etc.), as described herein. By enabling the subscribing service providers to maintain complete control (or at least not being controlled in any way by the system in terms of ownership of the subscribing service provider's practice), issues of fee-splitting regulations are generally avoided. For example, in some embodiments of the system may be a medical franchise that maintains strict compliance with medical laws, including fee-splitting regulations, and enables medical service providers to maintain complete control of their practice.

Enabling people to access premium medical services within a geographic area is important for improving the quality of life for those people who want or are in need of premium medical related services. Several embodiments of the system disclosed herein enable premium medical service providers to market their services efficiently (e.g., limited to no competition) with the option to invest in the system (e.g., partial ownership of the system including after retirement). Although embodiments of the system and methods disclosed herein may be discussed in the context of medical related service providers, other applications rendering a variety of services are also contemplated. For example, systems and methods discussed herein may be used for non-medical related services, cosmetic surgery services, elective and non-elective medical related services, non-premium services, sale of goods, or any other suitable sale of any goods and/or services.

Different types of medical related services are currently available, which generally include elective and non-elective procedures (e.g., cosmetic and/or reconstructive surgery, fertility treatment, mental health, cancer treatment, heart surgery, physical therapy). Some people have a need for or prefer to be counseled and/or treated by medical service providers, or medical-related service providers, who are specialists in their field and/or provide premium services. However, it may be difficult for some people seeking these types of services because they may not be easily directed to a single premium service provider in a geographic area.

For example, a person seeking the best cosmetic surgeon or cosmetic surgery clinic in a particular geographic area may find several advertisements claiming “the best” or “premium” services in cosmetic surgery from a variety of different cosmetic surgeons and/or cosmetic surgery clinics. Therefore, the service seeker, or potential patient, is generally not easily and conveniently presented with what has been identified to be a premium service provider (e.g., doctor and/or clinic) of a particular service or services in a generally defined geographic area.

In several embodiments, the system provides users of the system (e.g., potential patients) with the convenience of providing a variety of information to the users (e.g., advertisements related to services offered by premium service provider, questions and answers to medical related conditions and services), and a generally safe and secure way for each user to access information from the system and provide their own medical information to the system, as will be described in more detail below. As discussed above, the system does not provide the user with direct contact information regarding a specific medical practitioner until such time that a referral or appointment is arranged through the system. As a non-limiting example, if a user inquires with the system about orthopedic services, the user may be asked for her geographic location, her symptoms or orthopedic problems. Using that information, the system can provide the user with, for example, an initial assessment and a “System Clinic” which can be visited for further preliminary screening. At the System Clinic, there is no specific physician identified to the user, rather, the user interacts with the System Clinic to acquire for example, x-rays, physical exams, and a further diagnosis. At that time, the user will have the option of moving forward with an orthopedic procedure, or determining that such a procedure is not to be performed. Only once the user determines that going forward with the procedure is appropriate for her and sets up an appointment (or receives a referral), will the system release or identify a specific medical service provider, e.g., Dr. Jones, an orthopedic specialist subscriber to the system in the user's geographic area, will be the provider performing the procedure for user.

Some embodiments of system include one or more computers and computer interfaces, computer programs, one or more varieties of data storage media (e.g., hard drives, optical discs, digital databases, etc.), and a business network, as will also be discussed in more detail below. The system may additionally include one or more staff members for at least assisting in maintaining and upgrading the system, as well as to be available to assist in the methods and/or operations of the system.

In several embodiments, a business network within the system includes one or more service providers who have subscribed to the system. The system may form a contract with a service provider in order for the service provider to be officially subscribed to the system. In addition, upon the system subscribing a service provider, the system may then advertise nationally and/or internationally one or more services offered by the service provider in a generally defined geographic area. Furthermore, the system will generally exclusively advertise the subscribing service provider's services as being available generally only within the defined geographic area. This ensures that subscribing medical service providers are not placed in competition with other subscribing service providers within a generally defined geographic area. As discussed above, in several embodiments, the system itself is the externally recognizable entity, rather than an individual medical service provider. For clarity, and by way of example only, a system defined as “System X” has 4 subscribed medical service providers, one in the field of cosmetic surgery, one in the field of dental services, one in the field ocular services, and one in the field of emergency medicine. System X will not advertise the specifics of the services that are identifiable by the individual medical service providers. In other words, in some embodiments, advertising will not specifically identify the individual ocular service provider, but rather will advertise the ocular services that can be obtained through the system. However, in certain embodiments, the system can optionally be configured to specifically identify an individual medical service provider.

In addition, subscribing service providers may receive the benefit of one or more of their services being exclusively advertised at least nationally as a premium service provider in a generally defined geographic area. The size of a generally defined geographic area may vary between subscribing service providers (e.g., a city, a state, a town, etc.) and may depend on a number of factors (e.g., the type of service being offered by the subscribing service provider, the contractual agreement between the system and the service provider, etc.).

Generally, only under various limited circumstances will the system overlap the marketing of more than one service provider in a geographic area. In some circumstances one or a relatively small number of medical service providers may be the only providers of a particular medical related procedure (i.e., a new and/or highly specialized medical procedure) within a large geographic area (i.e., the United States, the world). In order for the system to meet the demands of the users of the system, in some embodiments, the system may enter into a contractual agreement with the limited number of highly specialized medical service providers that permits the system to geographically overlap, when necessary, the advertising and marketing of their highly specialized services. The system would take on the responsibility of ensuring that a generally fair distribution of potential patients are placed in contact with each of the subscribing highly specialized medical service providers who have contractually agreed to allow overlapping of the marketing and advertising of their services. For example, if there were only two medical service providers in the United States who were qualified to perform a particular highly specialized procedure and both lived in California and subscribed to the system, the system could enter into a contractual agreement with these two highly specialized service providers that allowed the system to at least partially overlap in the marketing and advertising of their services.

In several embodiments, the system advertises and markets the system in order to attract users to the system. Once a user has interacted with the system (i.e., registered with the system, provided some information to the system, etc.), the system may then provide the user with advertisements related to one or more services available to the user. Thereafter, the user may seek additional information or consultation from the system (e.g., from a system clinic). At such time that the user determines that an appointment is appropriate, the system will then provide specific information for a service provider.

Therefore, a user must at least interact with the system in order to obtain information about one or more subscribing service providers of the system. In several embodiments, a user interacts with the system (either partially or entirely) via computer (e.g., by accessing an interactive website of the system through the internet). In some embodiments, personal interaction between a user and a representative of the system is employed.

In some embodiments, the system advertises the services particular available through the system (e.g., the services provided by the various subscribing service providers, but not the service providers themselves) that are offered in a generally defined geographic area. Therefore, the in some embodiments, the system does not allow more than one service provider offering a particular service within the same generally defined geographic area. However, in some embodiments, the system does allow greater than one service provider of a similar service, in which case, the system apportions the distribution of prospective patients generally fairly between the multiple service providers. In some embodiments, the system may continue to renew or form new contracts with each subscribing service provider as long as good contractual standings are maintained with the system (e.g., the contract is not terminated for any reason). For example, in some embodiments, contracts formed between the system and a service provider may automatically expire a year after formation, while in other embodiments, the contracts are “at will” and readily terminable by the system or the service provider. In some embodiments, at the expiration of a contract (e.g., a year after formation of the contract), the system and the service provider may form a new contract or renew the expiring, or expired, contract. The system may take into account at least the financial contributions the system made to the service provider (e.g., the gross number of referrals made by the system to the service provider in the previous year and what profits were generated by these referrals to the service provider) in determining appropriate contractual financial terms for the new or renewed contract (i.e., the monthly cost to the service provider must pay in order to maintain a subscription to the system, etc.). Therefore, each year that a service provider subscribes to the system, contractual terms may vary according to the needs of at least either the system or the subscribing service provider. In some embodiments, as yearly revenues increase, the fees for contracting with the system increase. In such circumstances, the system has the potential to increase returns for investors (and for the system) over time. Increased revenue from contract fees allows the system to enhance the quality and scope of advertising of services, induce subscription by and maintain a higher quality of service provider, which in turn increases revenues due to providing services. Increased revenue from providing services then increases the value and revenue of the system, thereby increasing provider and investor loyalty to the system and the overall success of the system.

As generally described above, the system may benefit service providers who subscribe to the system. In general, the system may enable a service provider to subscribe to the system once a contractual agreement is in place between the system and the service provider. The contractual agreement may define a variety of terms and conditions that, if violated by either party, may terminate the contract. In some embodiments, the system may provide options for one or more service providers to invest in the system (e.g., purchase stock options, etc.). A service provider who invests in the system may not be obligated to renew a contract to maintain an investment in the system. Once the service provider (or any individual or entity that may or may not be a service provider) has invested in the system, the individual or entity is then able to maintain an investment in the system for generally as long as desired. A contract may be formed between the service provider and the system to define and secure the investment relationship between the two parties.

In several embodiments, the system collects yearly fees from each subscribing service provider in various installments (e.g., monthly, quarterly). The yearly fees are agreed upon during contractual formation with the system and are generally for the marketing and advertising of the service provider's services. In several embodiments, yearly fees are calculated by a computer algorithm that accounts for the revenue generated by the system as a whole and revenue attributable to a particular contracted service provider. Any financial arrangements between any service provider and the system abide by any and all fee-splitting regulations. In some embodiments, the system may enable service providers to subscribe to the system and form one or more contractual agreements with the system in exchange for the system to advertise and market one or more of the contracting service providers' services. In addition, the system would generally exclusively advertise and market nationally and/or internationally the one or more services of the service provider in a generally defined geographic area through the system (e.g., the system is advertised or branded, not the individual service provider).

An investment by a service provider may be a financial investment, which may be paid for up front or in installments to the system, and may enable the service provider to gain at least partial ownership of the system. In addition, the contractual agreement that may be formed between the system and a service provider may enable the service provider to receive financial returns on the service provider's investment as partial owner of the system. For example, a service provider who invests in at least a partial ownership of the system may receive financial returns during the service provider's working years and even after retirement, as described above. Thus, several embodiments of the present invention are advantageous over other advertising entities that do not offer continuing investment opportunities for service providers. As discussed above, the success of the system as a whole functions as an inducement for service providers. While investing in the system is much like a standard financial investment, the success of the system as a whole (in advertising and providing premium medical services) generates loyalty to the system among the providers. Loyalty is generated based on continued monitoring by the system of the revenue and quality of service (among other parameters) of each of the service providers. The maintenance of a high quality of service providers coordinately fosters the success of the system as a whole, and therefore provides returns (and additional inducement/loyalty to the system) to the service providers and investors. With this increased loyalty and the maintenance of high quality service providers, the fees for renewing each provider's contract with the system may be increased (either a flat rate, performance-based adjustment, percentage based, or other manner of allocation) to generate further revenue for the system.

Another advantage of several embodiments of the system may include limited to no competition between subscribing service providers of the system. For example, in some embodiments, a subscribing service provider is not forced to compete with other service providers within the geographic area that the service provider represents for specific services. This may be, at least in part, due to the contractual agreement formed between the system and the medical service provider, as generally described above. For example, a method of the system may include such steps as the system forming an agreement with a single medical service provider in order to provide national and/or international advertising of particular services offered by the medical service provider within a generally defined geographic area. As mentioned above, this generally limits, or eliminates, competition between service providers within a given geographic area for providing particular services to people (e.g., users of the system, potential patients). Therefore, once a user of the system determines that he/she wishes to receive a specific medical procedure and receives a referral or an appointment, the system then provides them with specific information for a specific physician within a generally defined geographic area.

The system may establish one or more financial and/or contractual agreements with one or more medical service providers. In some embodiments of the system, the business entity or network of the system may at least assist in forming agreements, or subscriptions, between the system and medical service providers in order to enable the subscribing service providers with an opportunity to financially invest in at least a part of the system in return for the system to advertise and market the medical service providers' services. However, the system may include contractual terms that may require subscribing service providers to at least pay a fee and abide by one or more contractually agreed upon rules. Some embodiments may include contractual terms that may be limited and/or terminated upon the system's discretion. For example, the system may require the service provider to maintain premium service rendering status (e.g., keeping up with advancements in medical technology and procedures), otherwise the system may terminate the contract between the system and the service provider. Furthermore, in some embodiments, the system may require the service provider to maintain generally good business relations with the system in order to maintain a contract in place between the system and the service provider. For example, a service provider that did not disclose required information to the system (e.g., informing the system of the types and number of procedures performed on patients acquired through the system) may enable the system to terminate the contractual agreement with the service provider. Any number of terms and conditions may be presented by the system, or business entity of the system, to a service provider interested in subscribing to the system, upon which any variation of contractual agreements may be arranged and contractually agreed upon between the system and the medical service provider.

As discussed above, the in several embodiments, the system includes one or more computers and associated computer programs. For instance, one or more programs may be included in the system for interacting with users of the system, such as potential patients. Furthermore, any one of the programs may be accessible by a user via the Internet, and may include a website based interaction. One or more programs, or software, may also be included in the system that may be downloadable by a user onto a computer or other variety of digital device. In one embodiment, a program enables a user to receive advertisements from the system related to medical services provided by premium medical service providers. In addition, some embodiments of a program of the system may enable a user to input information into the system. In some embodiments, a program may enable a user to acquire a user identification and password for future secure transmittal of information at least between the user and the system. In addition, any information provided by or pertaining to a user, including the user's identification and password, may be stored in one or more databases within the system. Additionally, any and all information entered, generated, and/or stored by the user may be maintained confidential to the user at all times, unless directed otherwise by the user (e.g., such as when the user wants certain information sent to a medical service provider of the system).

In some embodiments, at least one program of the system may be used to interact with subscribing, or potentially subscribing, medical service providers. For example, a program may track the occurrence of appointments made with any one of the subscribing medical service providers of the system. In addition, some embodiments of a program may further keep track of the number and types of services subscribing medical service providers are performing on users of the system. The information collected is optionally stored in a digital database (or other storage media) and later analyzed by the system to determine the financial contribution the system has made towards each subscribing medical service provider, which may further enable the system to determine future financial issues in accordance with the contractual agreements made between the system and medical service provider (e.g., how much the medical service provider must pay the system, what may be an appropriate contractual financial agreement between the system and a medical service provider for an upcoming year, etc.).

Some embodiments of the system include methods for at least assisting the system in determining one or more appropriate service providers to subscribe to the system.

In some embodiments, the system may include methods for determining one or more appropriate service providers to subscribe to the system for advertising their one or more services as premium services within a generally defined geographic area. For example, service providers may be chosen based on various criteria (e.g., user ratings, outside medical service provider rankings and patient feedback). In addition, service providers qualified as generally “premium” service providers of a particular service may be based on services offered and their geographic location for offering services. In some embodiments, contractual agreements between the system and one or more subscribing medical service providers will require the service providers to comply with contractual agreements in order to continue their subscription with the system. For example, contracts formed between the system and medical service providers may include yearly marketing fees that must be paid. By way of further example, the contracts may require the service provider to financially commit to a twelve month (or longer, e.g., 24 month) subscription with the option to re-subscribe at the end of the twelve months as long as the service provider has maintained good standings with the system (e.g., the system has received positive feedback from patients regarding the service provider, the service provider has fulfilled subscription payments, the service provider has maintained premium services, etc.). The incremental renewable contract is, in some embodiments, associated with increased fees that are based on the increased revenue of the system as a whole. Thus, the success of the system itself serves to generate additional revenue (e.g., contract fees), and thus functions to self-propagate the revenues generated by the system.

Some embodiments of the system may include contractual terms defining that the system agrees to not advertise particular services from other service providers within a generally defined geographic area As discussed above, since the system is externally recognized in some embodiments, and not the individual service provider, the system will provide advertisements related to the services available through the system in a generally defined geographic area. For example, the system may subscribe and nationally and/or internationally advertise a service available through the system, such as premium liposuction services in a particular geographic area. In some embodiments, the system may form a contractual agreement with the liposuction service provider that the system will not subscribe any other liposuction service providers within the particular geographic area in which that subscribing liposuction service provider will be providing services. Thus, in some embodiments, service providers providing a single type of service (e.g., liposuction) within a geographic area are not simultaneously subscribed. As discussed above however, in certain embodiments, an overlap in particular services is acceptable to the system, as the system provides a fairly apportioned distribution of patients to the multiple providers. In such embodiments, the system evaluates various parameters and data (e.g., revenue generated, number of procedures performed involving specific service, etc.) from each of the providers to make a fair distribution of potential patients. In some embodiments, the system may at least limit the number of contracts with other premium liposuction service providers within the particular geographic area.

Additionally, in some embodiments, without a contractual agreement specifically permitting the system to allow an overlap in marketing and advertising service that pertain to a limited number of highly specialized service providers, as described above, the system is not permitted to refer a potential patient outside of the geographic area the potential patient is residing within. Generally, only when a user (i.e., the potential patient) specifically requests a service provider outside of the user's residing geographic area can the system place the user in contact with a service provider outside of the user's residing geographic area.

In addition, the system may include one or more databases for storing information. The system may store information on one or more of system databases for future use. For example, the information stored in one or more databases of the system may include various information provided by the system, generated by the system, entered by one or more users (e.g., potential patients), and/or entered by one or more subscribing (or previously subscribed) medical service providers. For example, information stored in one or more databases by the system may include a user's medical history, one or more medical issues, contact information, payment information, login information (e.g., passwords, user identification, security information). As mentioned above, any and all information provided or generated by the system or entered by the user which pertains to the user may be generally maintained appropriately confidential at all times, unless directed otherwise by the user. By way of further example, information stored in one or more databases by the system may include a medical service provider's services offered, contact information, subscription information, and login information (e.g., passwords, user identification, and security information. Any and all information pertaining to any of the subscribing, or potentially subscribing, medical service providers may be generally maintained appropriately confidential as may be requested by the medical service provider.

Some embodiments of the system are directed to a system configured for assisting users of the system (e.g., potential patients) with their medical related issue or issues. The system may include at least one program accessible by one or more communication channels (e.g., internet) and may enable a user to interact with the program to answer one or more medical related questions and/or find a premium medical service provider that offers a particular service.

Some embodiments of the system may include marketing medical services over a wide geographic area and maintaining all subscribing medical service providers in strict compliance with fee-splitting regulations (e.g., according to United States standards). Some embodiments of the system comprise a virtual clinic offering medical related information to users of the system. For example, the virtual clinic may provide virtual consultations with users of the system. In addition, once the user has had a preliminary consultation or exam, the virtual clinic may place a user in generally direct contact with a medical related service provider to enable the user to have a consultation directly with the service provider (e.g., it is at this point the potential patient is placed in direct care or contact with the service provider). In some embodiments, system software assists in keeping track of each medical service provider (i.e., the number of potential patients directed to each service provider through the system) and each service provider is expected to interact with the system and/or system software to update the system with information relating to the number and types of services each patient (acquired through the system) had performed by the service provider. In some embodiments, each service provider must report any and all procedures and the financial accounting associated with each patient obtained through the system, which may be terms that were contractually agreed upon between the system and the service provider. Furthermore, the system may have additional contractually agreed upon rights to investigate into the users of the system and the service providers to ensure proper tracking of user visits to subscribing service providers are being accounted for by the system. For example, the system may follow up with users of the system to investigate which service providers the users obtained services from, how many services were obtained, and the costs associated with each procedure. Failure of a service provider to provide accurate information may result in the system's ability to terminate the service provider's contract with the system.

Some embodiments of the system may enable the user to pay the service provider through the system. Generally, the system and methods described herein may be adapted to any number of technologies, services, and features for at least enabling users to access medical related services and information. Some embodiments of the system may include one or more programs or software that enables one or more users to have a generally medical related consultation. In some embodiments of the system, the one or more programs or software that may enable a user to receive a medical related consultation may be downloadable by users onto a computer. In some embodiments, the user pays a required fee and/or registers with the system (e.g., the user must provide the system with information and/or setup a login and password with the system) in order for the user to receive a medical related consultation by the system (or program of the system).

For example, after a consultation by the system, e.g., a virtual consultation, the system may enable a potential patient to download additional software to at least enable the exchange of additional confidential information (e.g., medical history, medical condition, medication being taken by the user, etc.), and enable the potential patient to make an appointment with a subscribing medical service provider of the system. Furthermore, after the potential patient has determined to move forward with a procedure, the system can then place the potential patient in contact with a premium medical service provider based on the information gathered from at least the consultation. In addition, the system may place the user in contact with a premium service provider within a user defined geographic area (or outside a particular area, depending on a specific request provided by the user).

Some embodiments of the system may also include additional programs or software (which may use encrypted user login and password information to assist in maintaining the confidential identity of users while they interact with the system) that enable both communication (e.g., internet) and the transfer of funds between the system and users (e.g., subscribing medical service providers, potential patients). Some embodiments of the system may at least assist in managing patient contact (e.g., setting up appointments, procedure, consultations, etc.) with subscribing medical service providers. In some embodiments, the system may at least assist in managing the transfer of funds between the system and any user, service provider, or any combination thereof. In addition, the system may include one or more software and/or one or more databases to at least assist in managing the patient contact with subscribing service providers and/or transfer of funds, as described above. Furthermore, it has been contemplated that any number of databases and/or software or programs may be included in the system for at least assisting the system in managing one or more system operations, storage of information and/or transfer of information.

Some embodiments of the system may include one or more methods including steps for enabling the system to market medical services to potential patients in a national and international market. For example, the system may provide one or more marketing agreements between the system and various medical service providers to market their services for a fee. Any marketing fee may vary in terms of cost to the service provider and frequency of payment to the system. In addition, any of the marketing agreements may specify that the system will not form marketing contractual agreements with competitors offering services within a generally defined geographic area (such as in areas where service providers subscribing to the system are currently being marketed for one or more of their services). By way of example, a contractual agreement between the system and a service provider may terminate automatically after a year, and may further allow the service provider with the option to renew the contractual agreement—or a new variation of the contractual agreement. Upon termination or non-renewal of a contract between the system and a service provider, the system is then free to form at least one new contract with at least one new service provider over the generally defined geographic area that the terminated or non-renewed contract covered.

In some embodiments of the system, one or more programs or software may be used to track the performance of each contracting service provider by at least recording, for example, the number of potential patients the system referred to each subscribing service provider, the types and numbers of procedures performed or treatments rendered by each subscribing service provider on patients acquired through the system, and the fees attributable to the system and each subscribing service provider—which may be based on contractual agreements between the system and the service provider. For example, information generated by these types of programs and/or software may assist in the accounting of the system for proper acquiring and distribution of money to and from the system, respectively.

Some embodiments of the system include a website which may provide access to a virtual consultation (e.g., where a user may be provided with one or more opportunities to ask a question and receive an answer electronically and/or enter and receive information electronically, etc.). In addition, in some embodiments, the system may require a fee to be paid by the user in order to access and/or interact with the virtual consultation. For example, the virtual consultation may be interactive and in the form of an electronic question and answer session. By way of further example, the system may require a user to register with the system and obtain a user login and password in order to enable a user to download software and interact with a virtual consultation provided by the system. The system may require a user to register with the system before the system allows the user to enter personal information (including confidential information) in order to at least maintain the privacy and confidentiality of the user's information.

In some embodiments, one or more methods of the system may enable a potential patient to download software that may enable additional types of confidential information to be exchanged between the user, the system, and one or more subscribing service providers of the system. For example, various types of information may include, but are not limited to: information about the potential patient's medical history (e.g., family history, one or more procedures performed on the potential patient), information about the one or more procedures contemplated by the potential patient, the potential patient's consent to the one or more contemplated procedures, information detailing the fees of the one or more contemplated procedures, the billing information, and any other potentially confidential information. As described above, the system may require the user to register with the system prior to the sharing of at least any one of the above information in order to maintain the user's information and interaction with the system confidential. Some embodiments of the system may include software enabling encryption for at least confidential user or potential patient communication. Furthermore, some embodiments of the system may include software enabling encrypted user login and password systems and multi-security-level internet communication between contracting service providers and the system.

Some embodiments of the system include a marketing company engaged in national and international advertising services for contracted medical service providers (e.g., doctors, clinics, etc.), where each service provider may have exclusivity of providing services obtained and branded through the system within a generally designated geographic area. Each service provider may provide one or more services in an applicable field of expertise (e.g., plastic surgery). For example, in some embodiments, each medical service provider will remain “independent” (e.g., the doctor or clinic will retain all medical legal liability in connection with services performed, but will be tied to the marketing company by a marketing agreement). The marketing agreement may be for a defined term (e.g., twelve months) and may further guarantee exclusivity of potential patient referrals from the system to the service provider throughout the duration of the defined term (assuming one or more contractual agreements between the system and service provider are not terminated). Some embodiments of one or more marketing agreements of the system may indemnify the system against any and all medical legal liability (e.g., medical malpractice).

Some embodiments of one or more marketing agreements of the system enable the contracting service providers with an opportunity to renew their marketing agreement with the system. For example, in one embodiment, a service provider may have an opportunity to renew based on their full and complete performance of the expiring marketing agreement. By way of further example, in one embodiment, a service provider must continue to provide the requisite level and quality of service (e.g., premium services) in order to renew a marketing agreement with the system. In some embodiments, a service provider can optionally opt not to renew a marketing agreement (or contract) and form a new marketing agreement (or contract) with the system that may define new terms and conditions. Generally, the marketing agreement (or contract) may be a form agreement that is consistent with all “fee-splitting” medical referral laws at least in the United States. Some embodiments of the system may include one or more contractual agreements that may be utilized to avoid at least some of the following items: “fee splitting” penalties, practice ownership by the system, and medical legal liability on the part of the system.

Some embodiments of the system may include the ability to enable the transfer of medical consent by one or more prospective patients (e.g., consent validated by electronic signature) or other consent by the prospective patient (e.g., consent to arbitration) to one or more service providers. Some embodiments of the system may enable medical fees to be accepted by the prospective patient (e.g., by electronic signature using the secured “public key/private key” system). Additionally, some embodiments of the system may enable medical fees to be electronically transmitted from one or more prospective patients to the system (e.g., with the use of a credit card). Some embodiments of the system may enable one or more prospective patient's insurance information to be transmitted to the system to be directed to the appropriate service provider.

Some embodiments of the system may enable one or more photographs of the potential patient to be at least one of uploaded to the system, saved on one or more databases of the system, and/or transmitted to one or more appropriate subscribing service providers (e.g., one or more service providers identified by the potential patient). For example, any of the photographs uploaded to the system and/or transmitted by the system to a service provider may be altered by one or more medical service providers in order to suggest possible results of the potential patient in response to a contemplated procedure identified by a potential patient. The one or more altered photographs may be sent back to the potential patient for his or her consideration. This function and method of the system may save time and money for potential patients interested in services offered by medical related service providers (e.g., cosmetic surgeons).

As mentioned above, the system is not limited to the marketing of medical related services. Furthermore, the system may market and advertise for a variety of services, for example, including without limitation to the following: plastic/cosmetic surgery, dermatology, cosmetic dentistry, male hair restoration, laser rejuvenation, preventive medicine, nutritional therapy and supplements, human growth hormone therapy, skin care, etc.

As further mentioned above, the system may market and advertise for at least a variety of non-elective medical services and specialties, for example, including at least the following: internal medicine, cancer treatment and diagnosis, general surgery, orthopedic surgery, eye surgery (including vision-corrective laser surgery), urology, obstetrics, gynecology, etc.

Moreover, the system may provide a buying/selling service for the subscribing medical providers. For example, the service providers may optionally contract with the system to purchase, for example, medical liability insurance, disposable medical products, etc.). The system can thus provide for those subscribers that choose to opt in to the buying/selling service, the power of “bulk” purchasing. For example, a plurality of medical service providers that are known to be high quality can work with the system to purchase liability insurance at a better overall premium, as compared to what each individual provider could achieve on its own.

Some embodiments of the system include software or programs that enable a potential patient to learn about one or more medical service providers offering one or more services in a generally defined geographic area, make an appointment with one or more medical service providers (subscribing to the system), and arrange to engage in an in-person consultation with the identified subscribing medical service provider. Therefore, one of the benefits of the system is to place a user of the system in direct contact with a premium medical related service provider. In addition, in some embodiments, the system maintains these and other user, or potential patient, interactions with the system confidential, unless otherwise indicated by the user.

An example of a user interacting with the system includes steps such as the system providing one or more websites (all within the system, e.g,. not linked out to third party sites)accessible by a user. For example, if it is determined that a user of the system is in need of a medical product (e.g., crutches or a wheelchair), the system provides a means for the user to purchase such items through the system (e.g., a website). As such, the purchase of medical equipment, disposable medical products, medication and the like are all run through the system itself. As such, the system the contracts individually with suppliers of such items, allowing the system to obtain a price or contract that is optimal for the system, while still providing the user with a “one-stop” service for their medical needs.

The one or more websites provided by the system may contain general information relating to any number of medical services—or any number of goods and or services that may be advertised and marketed by the system, as described above. In addition, in some embodiments, the system enables a user to register with the system and obtain a user login and password. Once registered with the system, the system enables a user to interact with the system at an increased level of confidentiality, as well as enter user information into the system and obtain more user-specific information from the system. At this level of user interaction with the system, the system may interact with the user such that the system provides the user with a virtual clinic. In several embodiments, the virtual clinic of the system provides more specific answers to a user that has submitted more user-specific questions to the system—which may be related to one or more medical related conditions of the user. In addition, the system may offer additional services and features for an additional fee that the user must pay the system in order to obtain or use the additional services or features. For example, the system may offer direct user-interaction with a live medical service provider through the system (e.g., via the internet) and enable the user to have a generally live consultation with a medical service provider. Any number of services and/or features may be purchased by a user of the system and is not limited to the example given above. The system may also provide the user with at least contact information for setting up a face-to-face interaction (e.g., patient consultation, medical examination, medical related procedure, etc.) with a service provider subscribing with the system. In addition, some embodiments of the system may provide a service that enables a user to schedule an appointment through the system with a subscribing service provider. In general, the system provides multiple levels for the user to interact with the system for obtaining information and/or services (e.g., user does not register with the system, user registers with the system and obtains a user login and password, user pays system for added services and/or features, etc.).

Each of the methods, processes, subscriptions, evaluations, interactions, contracts and contract renewals, and any algorithms associated therewith, described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

While particular forms of embodiments have been illustrated and described, it will be apparent that various modifications can be made without departing from the spirit and scope of the embodiments herein. Accordingly, it is not intended that the invention be limited by the forgoing detailed description.

Modifications may be made to the foregoing embodiments without departing from the basic aspects of the system and/or methods. Although the system and methods may have been described in substantial detail with reference to one or more specific embodiments, changes may be made to the embodiments specifically disclosed in this application, yet these modifications and improvements are within the scope and spirit of the technology. Furthermore, the system and methods illustratively described herein suitably may be practiced in the absence of any element(s) not specifically disclosed herein. Although the present system and methods have been specifically disclosed by representative embodiments and optional features, modification and variation of the concepts herein disclosed may be made, and such modifications and variations may be considered within the scope of the invention.

What is claimed is:

1. A medical marketing service system comprising:
one or more computer processors;
a computer-readable storage media in communication with the one or more computer processors;
an electronic, searchable database stored on the computer-readable storage media that comprises information related to medical services, the database configured to store data relating to medical services offered by each of a plurality of medical service providers,
wherein each of said medical service providers pay a fee to contract with said medical marketing service to have its data maintained in said database in an active referral status;
a network port configured to receive information from an individual, the information relating to desired medical services,
the one or more computer processors configured to query said database based on the information received from said individual and, based on a plurality of evaluation factors, identify a best fit medical service provider from said plurality of medical service providers stored in the database and having an active referral status,
wherein said evaluation factors comprise one or more of specialization in a particular medical procedure, geographic location, patient feedback, outside medical service provider rankings, number of medical procedures performed, duration of contract with said medical marketing service, revenue generated for said medical marketing service, and adherence to contractual terms with said medical marketing service, and
wherein, after identification of said best fit medical service provider, transmitting an advertisement to said individual comprising information identifying the services provided by said best fit medical service provider, but without specifically identifying said best fit medical service provider.

2. A method for marketing a particular medical service comprising:
receiving information from an individual seeking a particular medical service, said information comprising information regarding the particular medical service sought;
using one or more computer processors to query an electronic, searchable database stored on computer-readable storage media that comprises, said database comprising data relating to medical services offered by each of a plurality of medical service providers,
wherein each of said medical service providers have contracted with a marketing service that houses said database to have its data maintained in said database in an active referral status,
wherein said database categorizes said medical service providers based on at least one particular medical service which said medical service provider provides;
wherein said query identifies, based on the information received from said individual and, based on a plurality of evaluation factors, identify a best fit medical service provider from said plurality of medical service providers stored in the database and having an active referral status,
wherein said evaluation factors comprise one or more of specialization in a particular medical procedure, geographic location, patient feedback, outside medical service provider rankings, number of medical procedures performed, duration of contract with said medical marketing service, revenue generated for said medical marketing service, and adherence to contractual terms with said medical marketing service; and
transmitting an advertisement to said individual comprising information identifying the services provided by said best fit medical service provider, but without specifically identifying said best fit medical service provider, thereby marketing a particular medical service.
